(19) United States
(12) Patent Application Publication
(10) Pub. No.: US 2019/0327116 A1
(43) Pub. Date: Oct. 24, 2019

(54) POLAR CODES FOR JOINT CHANNEL ESTIMATION AND ERROR CORRECTION

(71) Applicants: The Regents of the University of California, Oakland, CA (US); IDAC Holdings, Inc., WIlmington, DE (US)

(72) Inventors: Nadim Ghaddar, La Jolla, CA (US); Young-Han Kim, San Diego, CA (US); Laurence B. Milstein, La Jolla, CA (US); Liangping Ma, San Diego, CA (US); Byung K. Yi, San Diego, CA (US)

(21) Appl. No.: 16/387,211

(22) Filed: Apr. 17, 2019

Related U.S. Application Data
(60) Provisional application No. 62/662,123, filed on Apr. 24, 2018.

(51) Int. Cl. H04L 25/02; H04L 5/00; H04L 1/00

(52) U.S. Cl. CPC H04L 25/0238; H04L 5/0048; H04W 88/02; H04L 1/0057; H04L 1/0041

(57) ABSTRACT

Systems and methods are disclosed for combining successive cancellation decoding of polar coding with channel estimation, using a non-elementary mixture of information and redundancy bits for both channel estimation and error correction. For example, select bits of the polar encoder output may be used for an implicit parity check. Reliably-decoded bits may be iteratively incorporated into the set of pilots. The result is a semi-blind approach for channel estimation, which may have applicability to common wireless communication systems, particularly a cellular control channel, or transmissions of short messages on a cellular data channel.

### BACKGROUND

In some current communication systems, channel estimation and channel coding are performed separately, in order to minimize the complexity. A common paradigm is that even when data transmission occurs over time-varying channels with unknown parameters, the receiver is able to compute accurate estimates of those unknown parameters. In most practical systems, a known training sequence (known as a pilot sequence) is transmitted to help the receiver in this task. Once the channel estimates are computed, subsequent operations at the receiver side, such as channel equalization and decoding, can follow. Thus, a transmitter alternates between transmitting a known training sequence (which is pure redundancy, which is suboptimal according to A. Lapidoth and P. Narayan, “Reliable communication under channel uncertainty,” IEEE Transactions on Information Theory, vol. 44, pp. 2148-2177, October 1998), with sending encoded information. Knowledge of the training sequence at the receiver is used to estimate unknown channel parameters, which are subsequently utilized to decode the later-transmitted information.

Recently-developed polar codes can achieve symmetric capacity on binary discrete memoryless channels, in some scenarios, even with low encoding and decoding complexity. A fundamental component of the polar coding scheme is a successive cancellation decoder which, for the specific construction of polar codes, can be implemented with appreciable efficiency.

### SUMMARY

Systems and methods are disclosed for combining successive cancellation decoding of polar coding with channel estimation, using a non-elementary mixture of information and redundancy bits for both channel estimation and error correction. For example, select bits of the polar encoder output may be used for an implicit parity check. Reliably-decoded bits may be iteratively incorporated into the set of pilots. The result is a semi-blind approach for channel estimation, which may have applicability to common wireless communication systems, for transmissions on a cellular control channel, or transmissions of short messages on a cellular data channel.

In some embodiments, a method of wireless communication may include receiving an indicator for joint channel estimation; receiving an indicator for pilot signal density; and responsive to receiving the indicator for joint channel estimation: setting the portion of allocated resources to be used for channel estimation according to the indicator for pilot signal density; mapping codeword bits to symbols; mapping symbols to allocated resources; and transmitting the symbols. For some embodiments of the method, transmitting the symbols may include transmitting a systematic polar coded signal and may also include using the indicator for pilot signal density and a transport block size to determine a length of a polar coding vector w and mapping a pilot sequence based on the polar coding vector w. For some embodiments of the method, transmitting the symbols may include transmitting a non-systematic polar coded signal and may also include using the indicator for pilot signal density and a transport block size to determine a length of a polar coding set B and mapping a pilot sequence based on the polar coding set B. Some embodiments of the method may be performed by a user equipment (UE) or by a base station.

In some embodiments, a method of wireless communication may include receiving an indicator for joint channel estimation; receiving an indicator for pilot signal density; and responsive to receiving the indicator for joint channel estimation: using the indicator for pilot signal density to identify information bits and pilot signal in a received signal; and performing joint polar decoding and channel estimation. For some embodiments of the method, transport block size may additionally be used to identify information bits and pilot signal in a received signaling. For some embodiments, receiving is receiving at a UE, and the received signal is an allocated downlink resource. For some embodiments, receiving is receiving at a base station.

In some embodiments, a method of wireless communication includes receiving, at a UE, an indicator for joint channel estimation; receiving, at the UE, an indicator for pilot signal density; and responsive to receiving the indicator for joint channel estimation: performing systematic polar coding or non-systematic polar coding. A system for wireless communication may include: a processor; and a non-transitory computer-readable medium storing instructions that are operative, when executed by the processor, to perform the methods disclosed herein.

### BRIEF DESCRIPTION OF THE DRAWINGS

A more detailed understanding may be had from the following description, presented by way of example in conjunction with the accompanying drawings. Furthermore, like reference numerals in the figures indicate like elements.

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 10 is a system diagram illustrating an example radio access network (RAN) and an example core network (CN) that may be used within the communications system illustrated in FIG. 1A according to an embodiment.

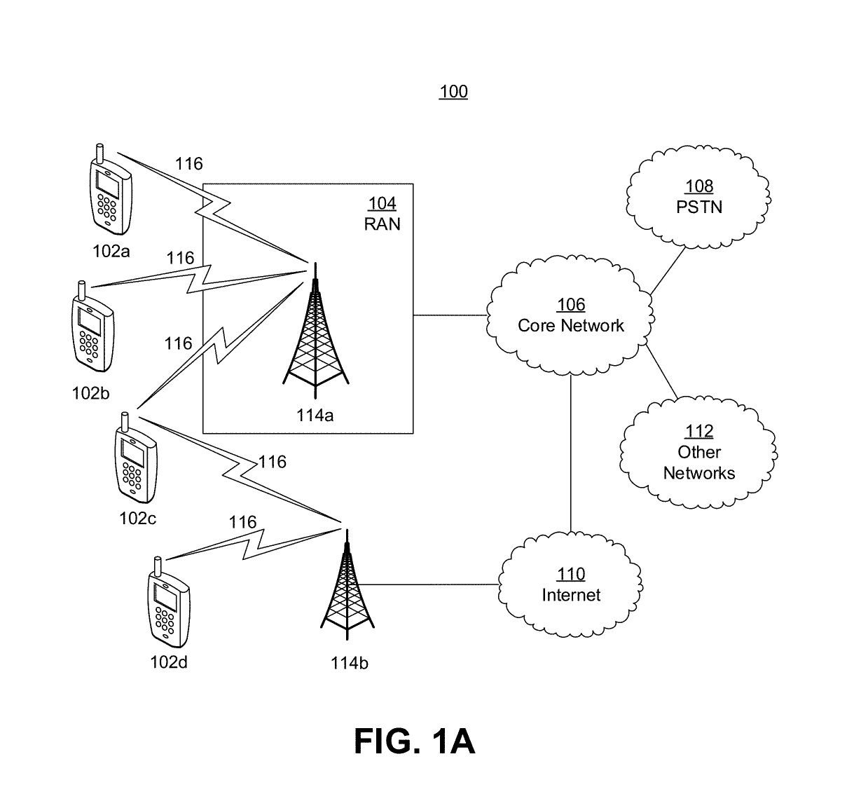

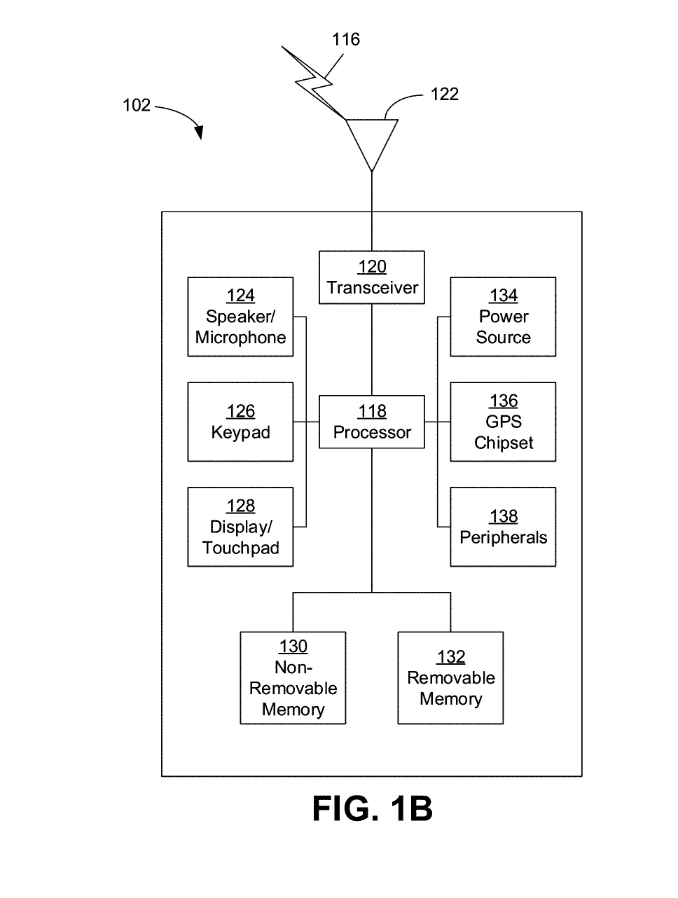

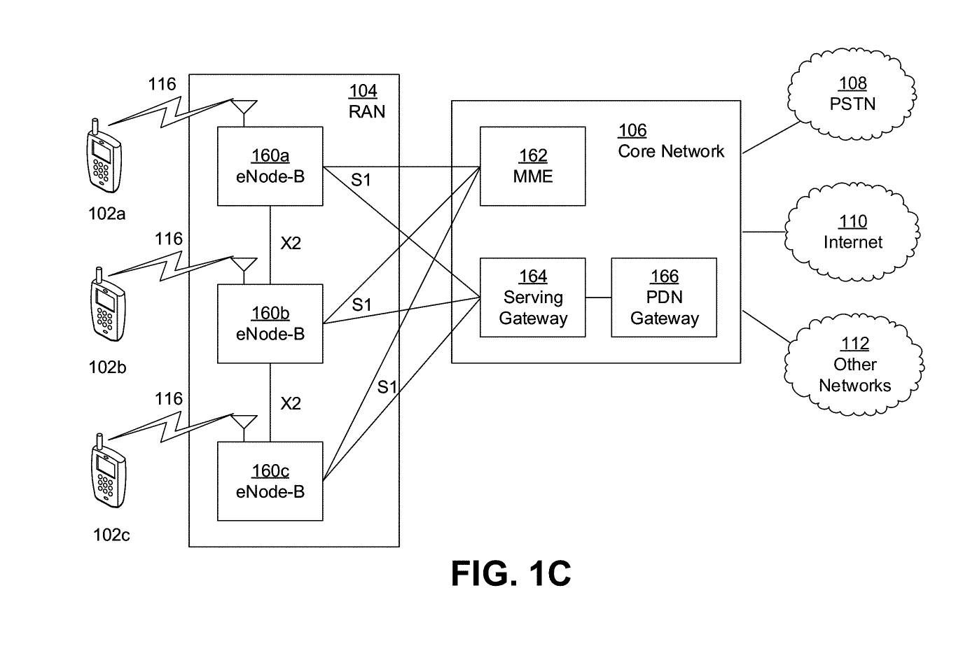

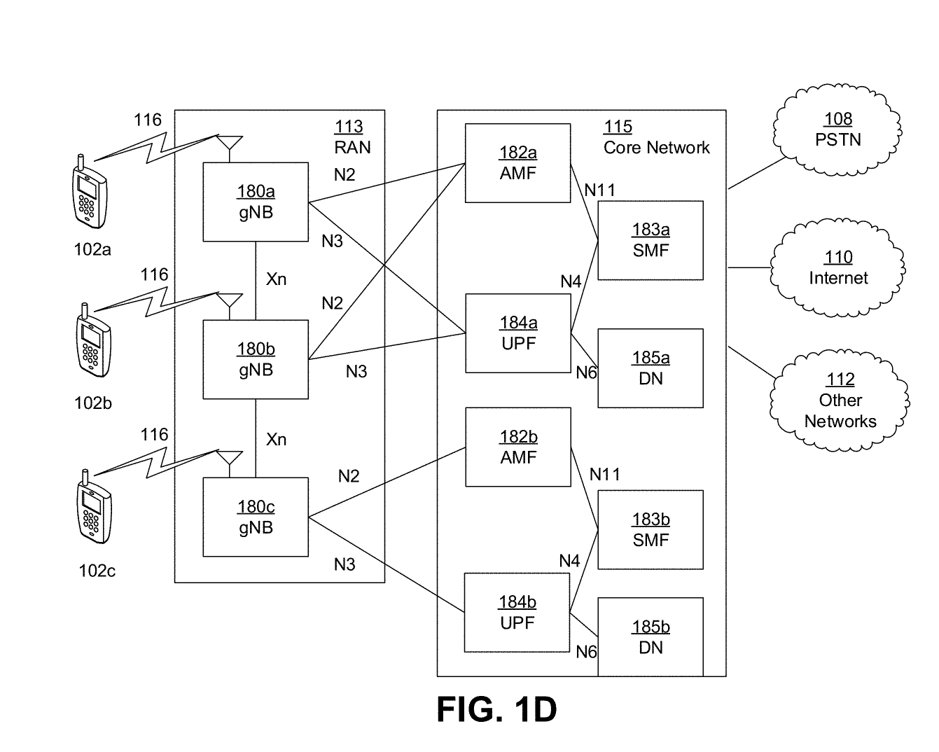

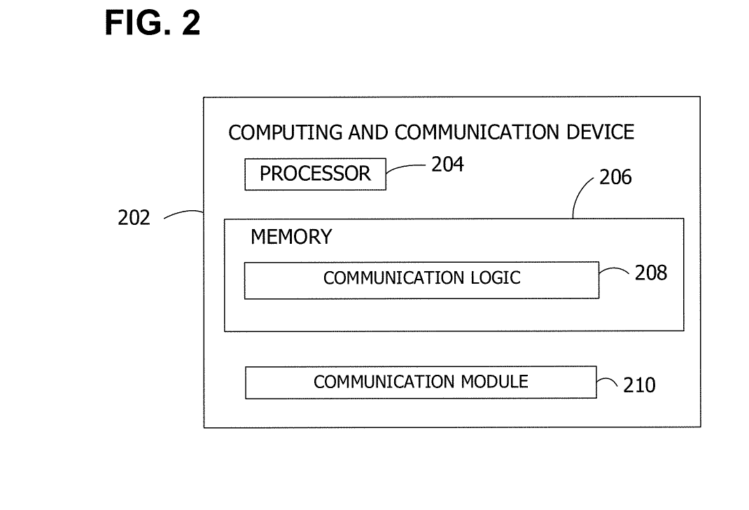

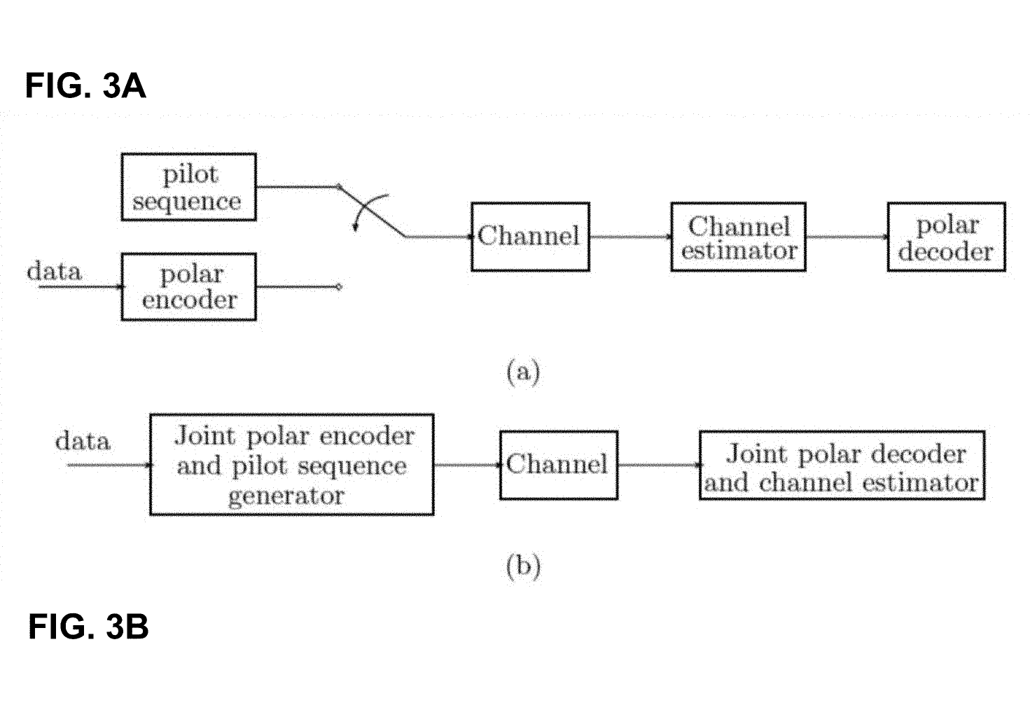

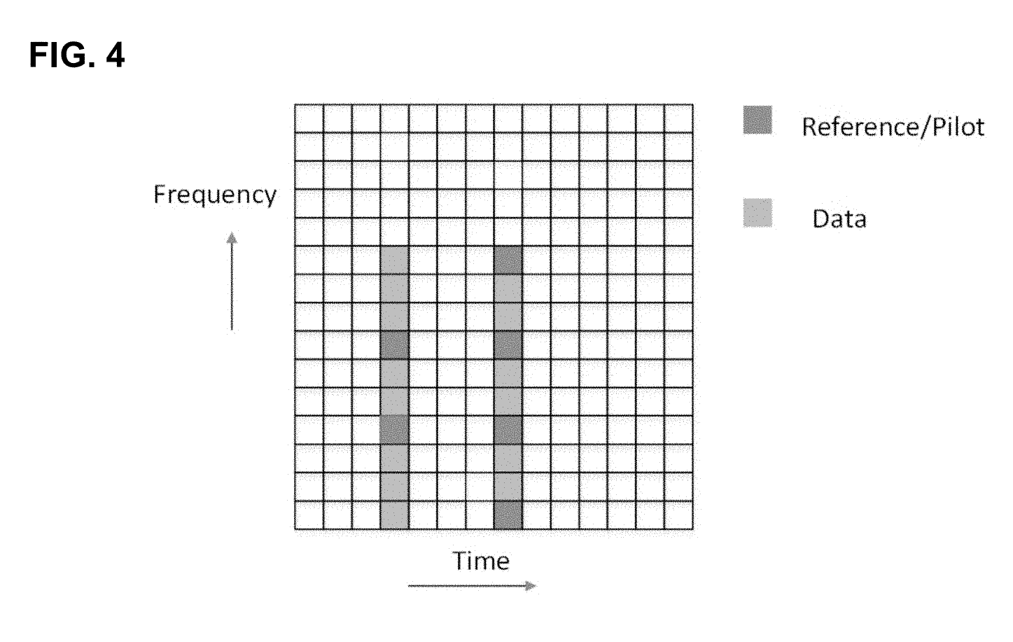

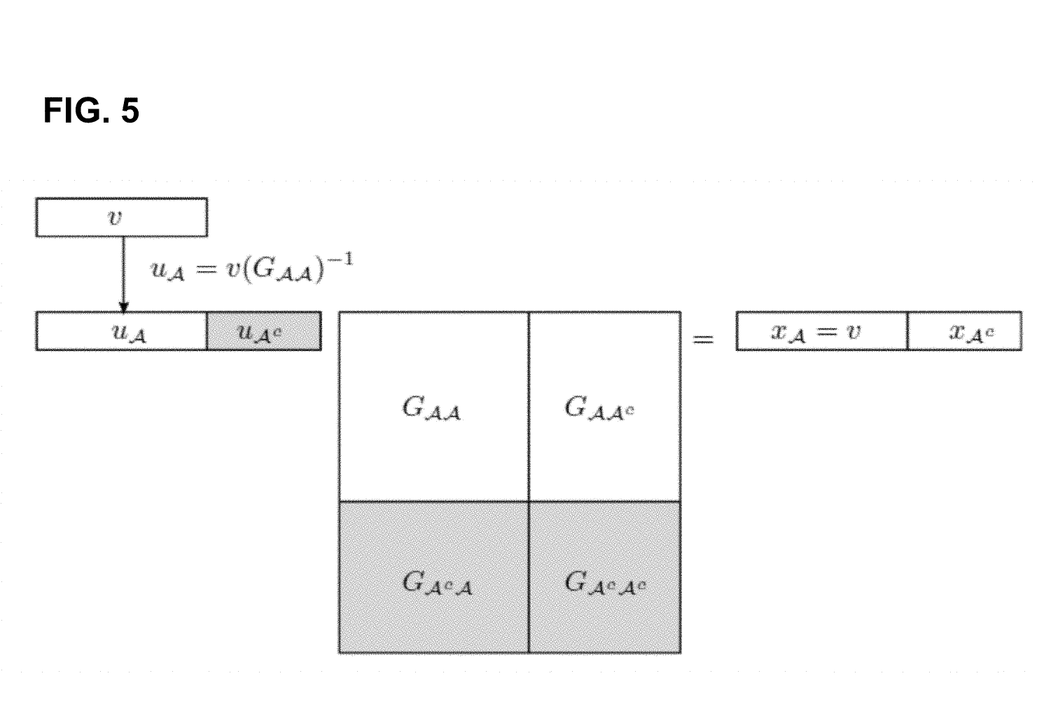

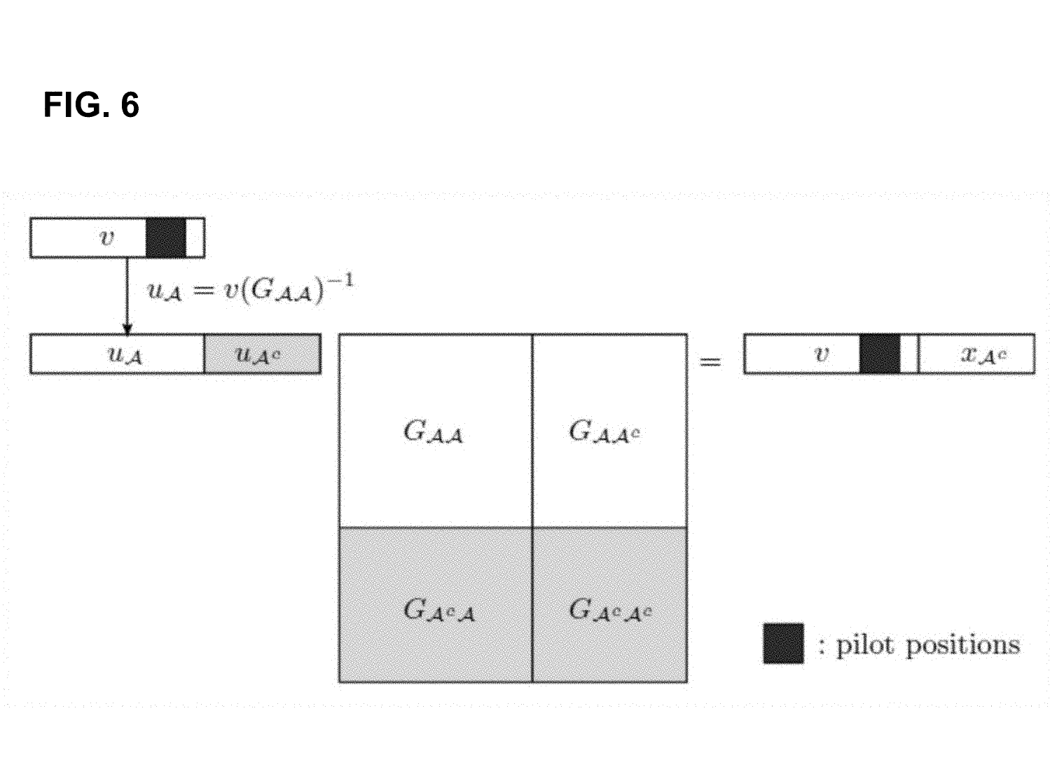

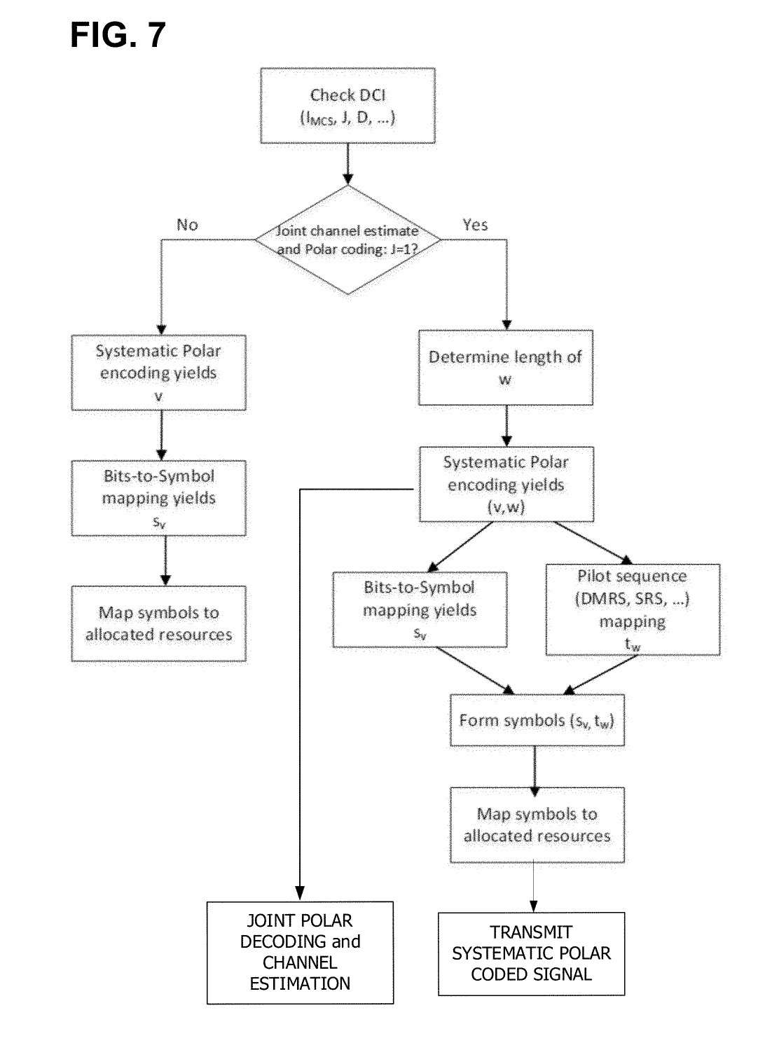

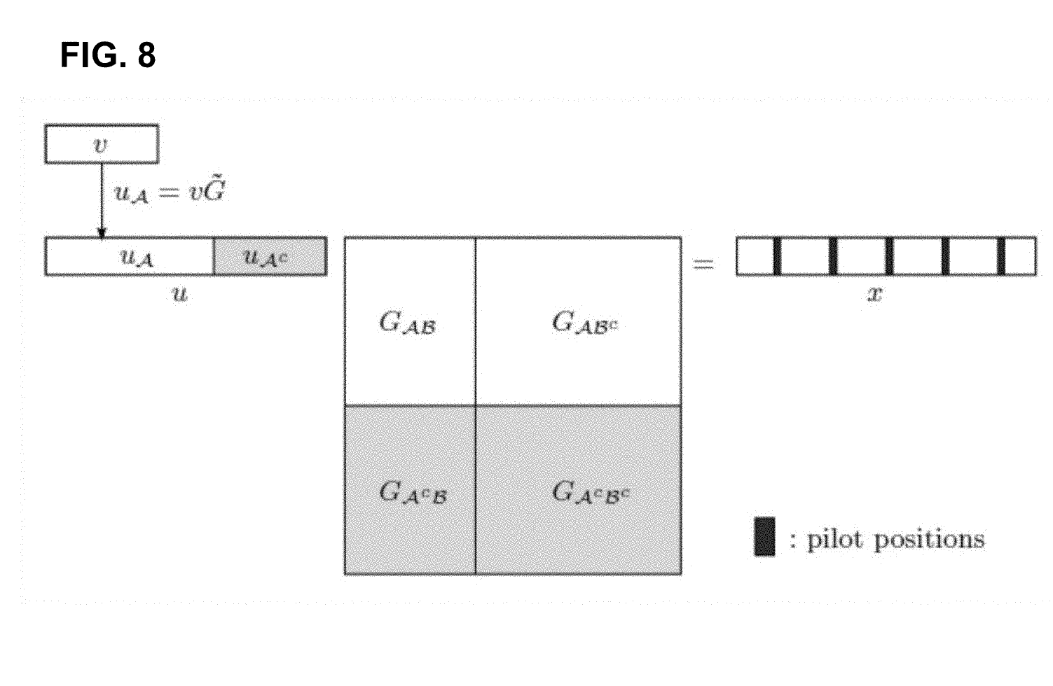

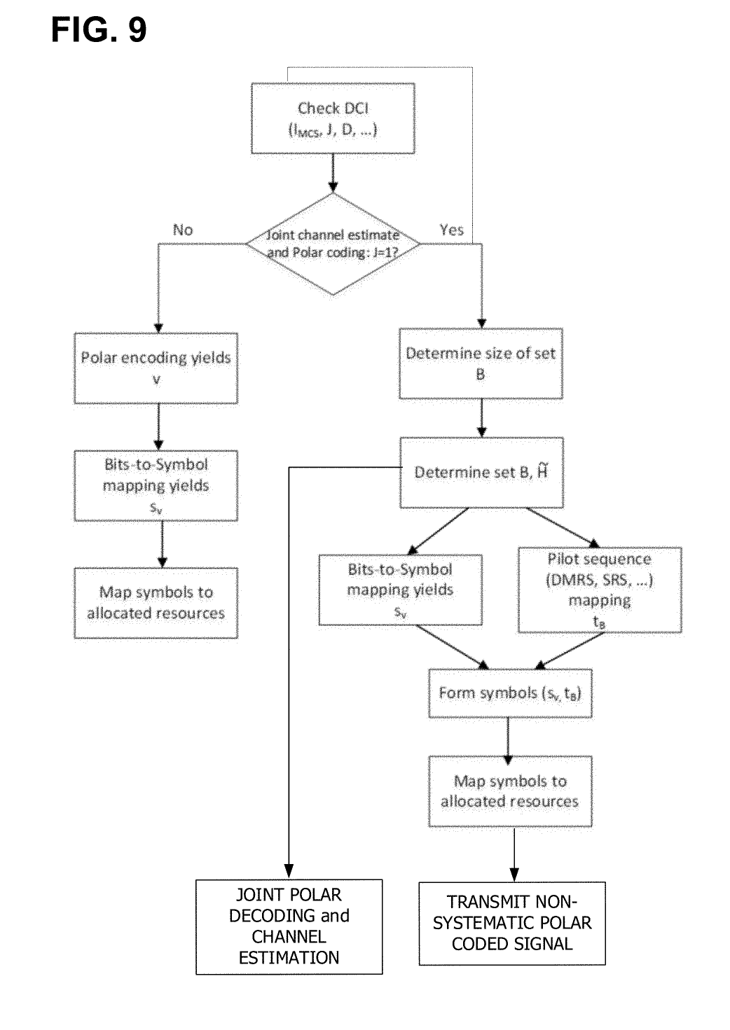

FIG. 1D is a system diagram illustrating a further example RAN and a further example CN that may be used within the communications system illustrated in FIG. 1A according to an embodiment.

FIG. 2 illustrates a computing and communication device (WTRU) that may advantageously implement discloses systems and methods, according to some embodiments.

FIG. 3A illustrates a scheme of alternating training and encoding.

FIG. 3B illustrates an example scheme that implements a combined successive cancellation decoding of polar codes and channel estimation, according to some embodiments.

FIG. 4 illustrates an example time versus frequency grid having reference and data blocks.

FIG. 5 illustrates an example of systematic polar encoding.

FIG. 6 illustrates an example of piloting using systematic polar codes, according to some embodiments.

FIG. 7 illustrates a flow chart of an example method that may be performed by a WTRU, according to some embodiments.

FIG. 8 illustrates an example of joint channel estimation and non-systematic polar coding, according to some embodiments.

FIG. 9 illustrates a flow chart of an example method that may be performed by a WTRU, according to some embodiments.

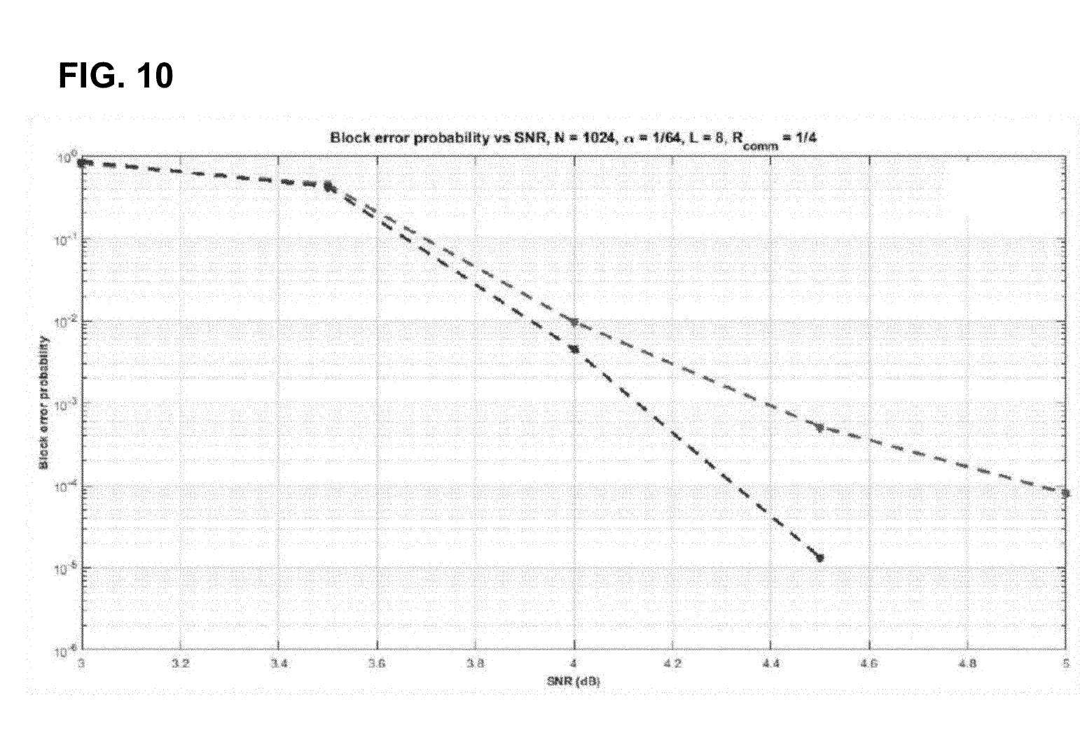

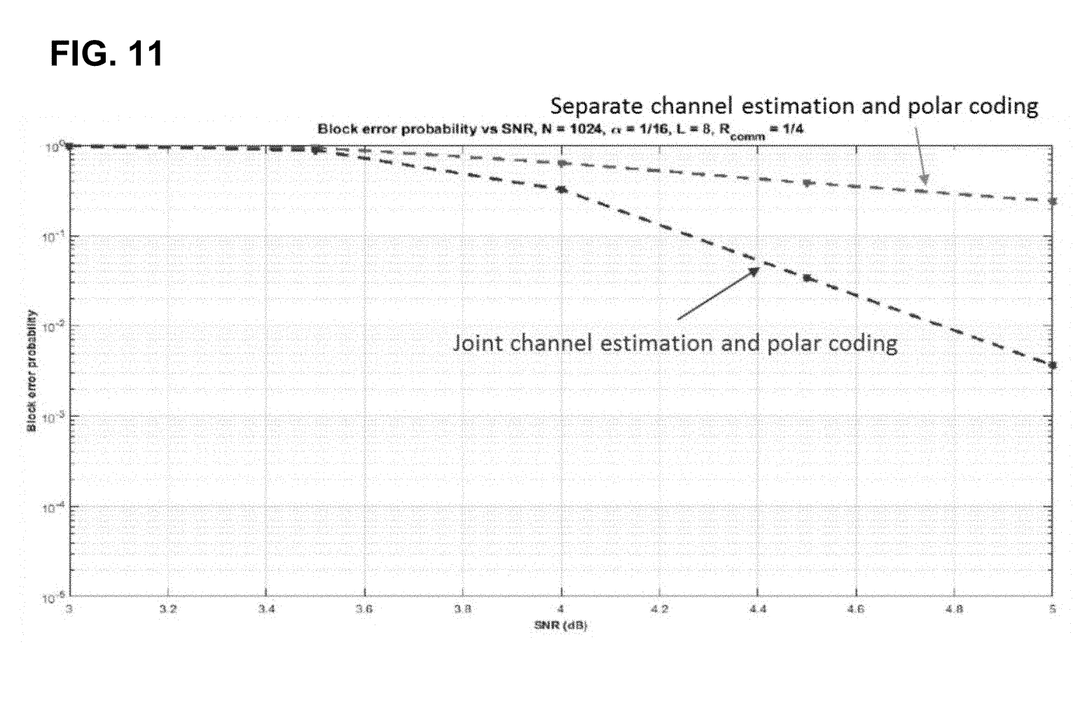

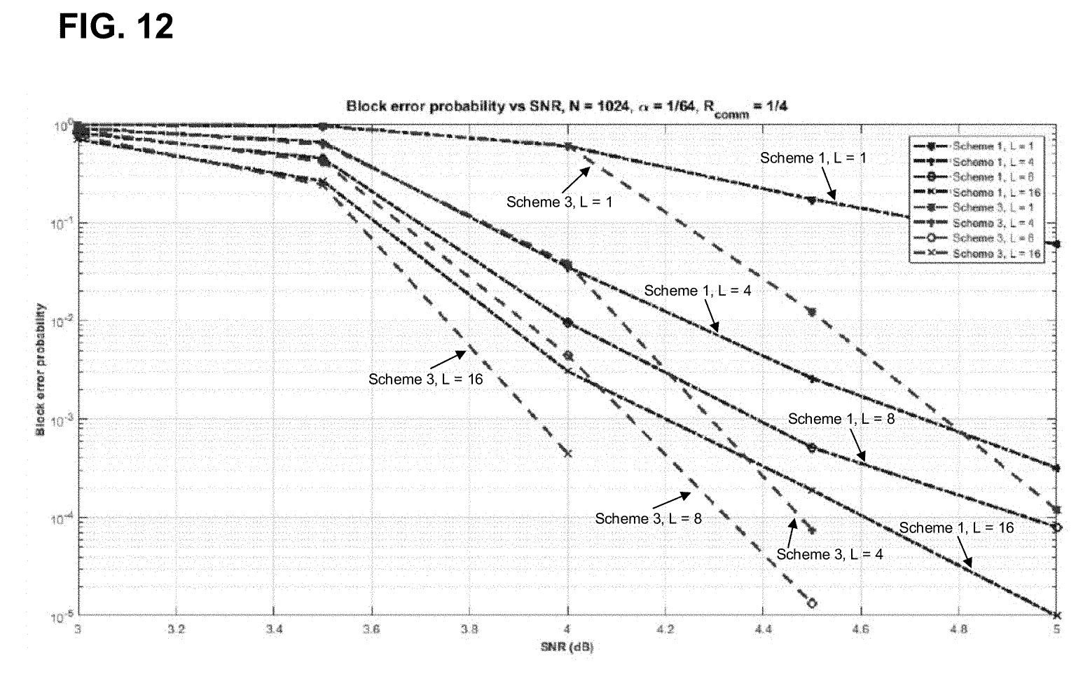

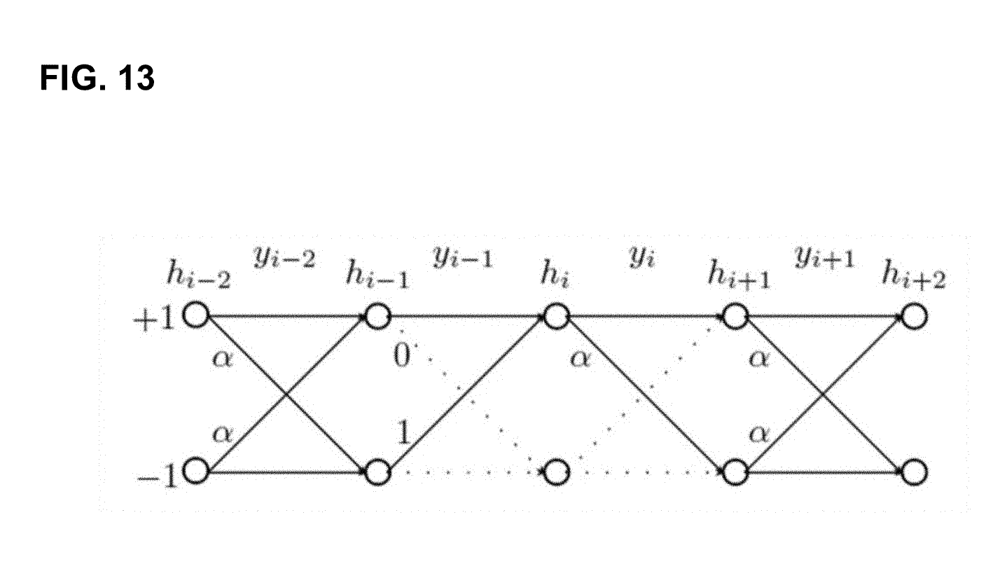

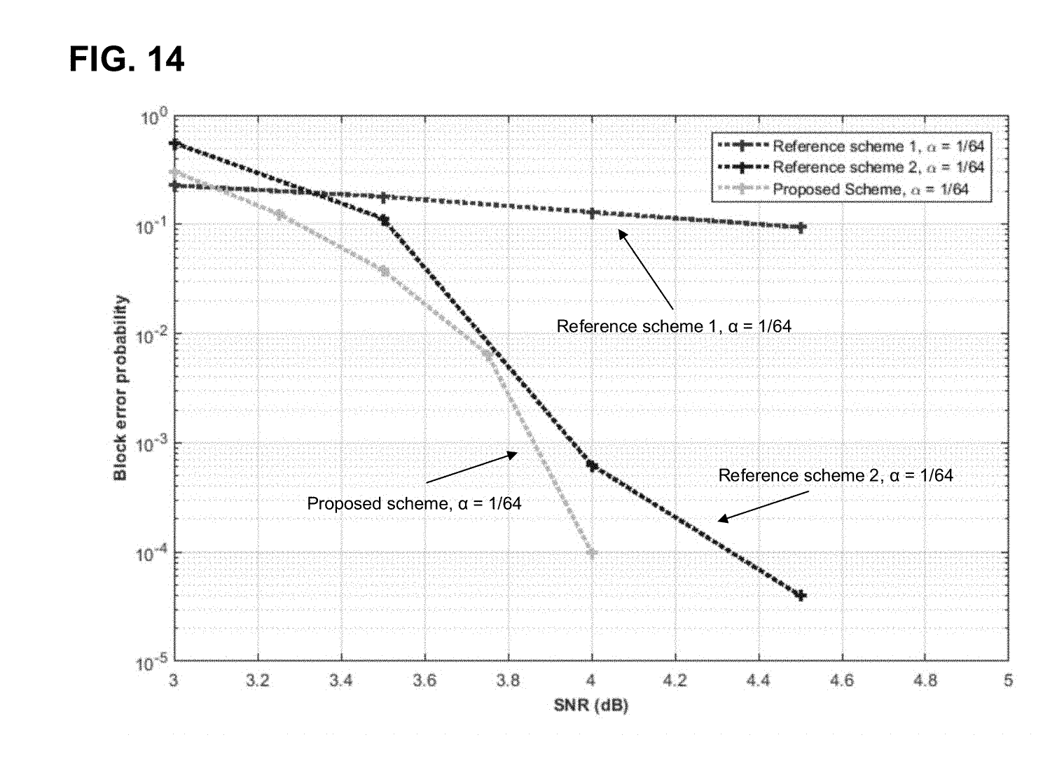

FIGS. 10-12 illustrate simulation results for channel models, according to some embodiments.

FIG. 13 depicts an embodiment of a modification to SCTD.

FIG. 14 depicts block error probability performance of the different described embodiments.

The entities, connections, arrangements, and the like that are depicted in, and in connection with, the various figures are presented by way of example and not by way of limitation. As such, any and all statements or other indications as to what a particular figure depicts, what a particular element or entity in a particular figure is or has, and any and all similar statements, that may in isolation and out of context be read as absolute and therefore limiting, may only properly be read as being constructively preceded by a clause such as “In at least some embodiments, . . . ” For brevity and clarity of presentation, this implied leading clause is not repeated ad nauseum in the detailed description of the drawings.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

### Example Networks for Implementation of the Embodiments

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 10 is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 10, the eNode-Bs 160a, 160b, 160c may communicate with one another over an X2 interface.

The CN 106 shown in FIG. 10 may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

FIG. 2 illustrates a computing and communication device (perhaps a WTRU as described for FIGS. 1A-1D) 202 that may advantageously implement disclosed systems and methods, according to some embodiments. As illustrated, computing and communication device 202 comprises a processor 204, a memory 206, and a communications module 210. Memory 206 is a non-transitory computer-readable medium, and holds communication logic 208 that contains logic (whether implemented in circuitry and/or instructions) for implementing methods disclosed herein. Processor 204 is illustrated as a generic single processor, but may comprise multiple processors), and is configured to execute instructions stored in memory 206. Communication module 210 may be configured to communicate with networks, similarly as is described for FIGS. 1A-1B.

### Polar Coding.

Systems and methods are disclosed for combining successive cancellation decoding of polar coding with channel estimation, using a non-elementary mixture of information and redundancy bits for both channel estimation and error correction. For example, select bits of the polar encoder output may be used for an implicit parity check. The result is a semi-blind approach for channel estimation, which may have applicability to common wireless communication systems, particularly a cellular control channel. In some embodiments, an example iterative channel estimation and decoding scheme may be used that incorporates reliably-decoded bits into the set of pilots.

Recently-developed polar codes can achieve symmetric capacity on binary discrete memoryless channels, in some scenarios, even with low encoding and decoding complexity. A fundamental component of the polar coding scheme is a successive cancellation decoder which, for the specific construction of polar codes, can be implemented with appreciable efficiency.

Polar codes have been described by Arikan (E. Arikan, “Channel polarization: A method for constructing capacity-achieving codes for symmetric binary-input memoryless channels,” IEEE Transactions on Information Theory, vol. 55, pp. 3051-3073, July 2009 (“Arikan_1”)), polar codes are one of the recent breakthroughs in coding theory. These codes achieve the symmetric capacity on any binary discrete memoryless channel and also have low encoding and decoding complexities. A fundamental component of the polar coding scheme is a successive cancellation decoder which, for the specific construction of polar codes, can be implemented efficiently.

Polar coding leverages a phenomenon commonly referred to as channel polarization. Given N=2n independent copies of a channel, it is possible to synthesize N new channels, a fraction of which are near perfect (capacity 1) and the rest are near useless (capacity 0). Thus, one can transmit uncoded bits over the near perfect channels, and freeze the bits over the near useless channels to known values. The generator matrix G of the polar code is the n-fold Kronecker product of the matrix

$$F = [ \begin{matrix}1 & 0 \\ 1 & 1\end{matrix} ] ,$$

where G=F^{⊗n}.

The following notation will be used: For any set A⊆{1, . . . , N}, denote its set complement as A^{c}, defined as follows: A^{c}={i∈{1, . . . , N}, i∉A}. Also, for any vector u∈F₂^{N} and set A∈{1, . . . , N}, define u_{A}=(uᵢ,i∈A). We denote the N-bit information vector as u (we can write u=(u_{A},u_{A}_{^{c}}), where A is the information set and u_{A}_{^{c}} is the set of frozen bits (set to zero)), and let x be the corresponding codeword, where. x=uG.

FIG. 3A illustrates a polar encoder communication system in which channel estimation and channel coding are performed separately. A known training sequence (the illustrated pilot sequence) is transmitted to help the receiver in this task. Knowledge of the training sequence at the receiver is used to estimate unknown channel parameters. Once the channel estimates are computed, subsequent operations at the receiver side, such as channel equalization and decoding, can follow. Thus, the transmitter is illustrated as being able to switch from transmitting a pilot sequence to sending polar encoded data, while at the other end, the receiver uses channel estimates in polar decoding.

The system of FIG. 3A minimizes complexity, which may, in some situations, be desirable for long messages. However, for short messages, such as may occur on a cellular control channel, a joint approach of polar coding and channel estimation may reap additional gain without suffering from high complexity. That is, a joint approach, an example of which is shown in FIG. 3B, may offer a performance gain, while the short message length can keep complexity relatively low.

Thus, FIG. 3B illustrates a scheme that can combine the successive cancellation decoding of polar codes with a channel estimation procedure, according to some embodiments. In some embodiments, a possible scheme may use a non-elementary mixture of information and redundancy bits for both channel estimation and error correction. The example embodiments shown combine successive cancellation decoding and channel estimation, along with using certain bits in the polar encoder output for an implicit parity check. The scheme can thus be described as a “semi-blind” approach for the channel estimation problem.

FIG. 4 illustrates an example time versus frequency grid having both reference/pilot signal and data blocks. As illustrated, the reference/pilot signals occupy specific frequency spots in the different transmission time slots. The darker blocks represent the resources for reference/pilot signals, while the light gray blocks represent those for the data. In a typical communication system, the density of the reference/pilot signal (the ratio of the amount of resources used for reference/pilot signals to the total resources used for data), is fixed or allowed to change via explicit configuration.

Polar codes in their standard form are non-systematic. However, like any linear code, an equivalent systematic polar code exists. Due to the structure of the generator matrix G, the systematic polar code can be constructed efficiently in O(N log N) complexity. The following example construction procedure of a systematic polar code is presented and briefly outlined.

Consider any set B⊆{1, . . . , N} and write x=(x_{B}, x_{B}_{^{c}}). Therefore, it can be written that

$$\begin{matrix}{x}_{B} = {u}_{A} {G}_{AB} & Eq . ( 1 ) \\ {x}_{{B}^{c}} = {u}_{A} {G}_{{AB}^{c}} & Eq . ( 2 )\end{matrix}$$

where G_{AB}=(G_{i,j})_{i∈A,j∈B}. To construct a systematic polar encoder with inputs an information vector v∈{0,1}^{k}, where k is the number of information bits, let x_{B}=v. To compute the “parity bits” x_{B}_{^{c}}, it can be shown from equations (1) and (2) that

$$\begin{matrix}{u}_{A} = {{x}_{B} ( {G}_{AB} )}^{- 1} = {v ( {G}_{AB} )}^{- 1} & Eq . ( 3 ) \\ {x}_{{B}^{c}} = {v ( {G}_{AB} )}^{- 1} {G}_{{AB}^{c}} & Eq . ( 4 )\end{matrix}$$

Therefore, the systematic encoding function is described as a mapping v→(x=v, x_{c}) using equations (3) and (4). Note that this mapping is valid if and only if |A|=|B| and G_{AB} is invertible. It is shown in E. Arikan, “Systematic polar coding,” IEEE Communications Letters, vol. 15, pp. 860-862, August 2011 (“Arikan_2”) that having B=A satisfies these conditions.

### Joint Channel Estimation and Systematic Polar Coding.

FIG. 5 illustrates an example encoding procedure for systematic polar codes. Polar codes were originally introduced as a class of non-systematic linear block codes. The adaptation to systemic polar codes, illustrated in FIG. 5 provides a basis for a joint channel estimation adaptation.

Some embodiments may use systematic polar codes to fix some bits in the codeword x (also in the input information vector v) to a known value to the decoder, such as perhaps zero. These fixed bits not only may be used to estimate unknown channel parameters, but may also contribute to the polar decoding procedure. As their value is known to be zero, the decoder sets the corresponding log-likelihood ratios at these positions to +∞. Also, since pilots are sent as part of the codeword, a larger code blocklength can be supported, which implies an improved performance for polar codes, since bit-channels become more “polarized” at larger blocklengths. See FIG. 6, illustrating an example of piloting using systematic polar codes, according to some embodiments. In FIG. 6, pilot positions may be seen in the information vectors v.

In addition to the preceding benefits, a further embodiment of the systems and methods includes list decoding of polar codes (I. Tal and A. Vardy, “List decoding of polar codes,” IEEE Transactions on Information Theory, vol. 61, pp. 2213-2226, May 2015 (“Tal”)). As some bits in the codeword x are known to be zero, this fact can be used to choose from different output candidates of list decoding. Assuming the output of list decoding is a list of candidate vectors {\hat{v}₁,L,\hat{v}_{L}}, where L is the list size, the output of the polar decoder would be the vector \hat{v}ᵢ that satisfies that the corresponding codeword \hat{x}ᵢ having zeros at the known pilot positions. In that sense, the piloting scheme plays a similar role as cyclic redundancy check (CRC) bits in CRC-concatenated polar codes. The length of v may be determined by a target coding rate.

In this example, part of the information bit vector v is used as pilot bits, which reduces the coding rate. To avoid this, the vector v may be artificially enlarged to vector v′=(v, w), and the same procedure may be applied to v′. The vector v′ will appear in the codeword, and w may be used as the pilot. The pilot bits may be mapped to symbols, which are then spread among the allocated resources for effectively sampling the channel by following, e.g., a procedure known to the receiver. The details may be as follows, as shown in FIG. 7.

FIG. 7 illustrates a flow chart of an example method that may be performed by a WTRU for joint channel estimation and systematic Polar coding for the uplink, according to some embodiments. In some embodiments, the base station may send the configuration for joint channel estimation and polar coding in downlink control information (DCI), which may contain, in addition to parameters such as the modulation and coding index (I_{MCS}), two new parameters:
J: the indicator for joint channel estimation and polar coding. If J=1, the joint processing is configured for the UE; if J=0, the joint processing is not configured for the UE and the UE is configured to do separate channel estimation and polar coding.
D: the pilot signal density parameter. D may be used to adjust the proportion of the allocated resources to be used for the channel estimation purpose. This configuration gives the system the flexibility of adapting the pilot density to the channel coherence time and coherence bandwidth. For example, when the channel is highly variable as indicated by a narrow coherence bandwidth and/or short coherence time, the parameter D may take a larger value to increase the pilot density. On the other hand, if the channel does not change much in frequency or in time, the parameter D may take a smaller value to decrease the pilot density.

The parameter D may be an index, indicating different pilot densities. For example, see Table 1:

TABLE 1

| D | 0 | 1 | 2 | 3 |
|---|---|---|---|---|
| Pilot density | 1/32 | 1/16 | ⅛ | ¼ |

where 0 means that the pilot density is 1/32, i.e., 1/32 of the codeword bits or symbols or resources that will be used for pilot signal (or a similar meaning). Whether the pilot density is measured in codeword bits, symbols, or resources depends on the configuration, for example, configuration through the radio resource control (RRC) or a semi-static configuration in the DCI.

The pilot density parameter D may be used, together with the transport block size (TBS), by the UE to determine the length of w. For example,

L_{w}=ceiling(TBS×(pilot density)) Eq. (5)

where ceiling( ) is the ceiling function that takes the smallest integer greater than the input argument. The length of vector v′ will be Lᵥ+L_{w}, where Lᵥ is the length of vector v.

The Polar encoding is as follows. First, the following is calculated,

u′_{A′}=(vw)(G_{A′A′})⁻¹ Eq. (6)

where A′ is the submatrix of generator matrix G, consisting of the Lᵥ+L_{w} rows and Lᵥ+L_{w} columns.

Next is the Polar transformation

$${u}_{{A}^{′}}^{′} ( \begin{matrix}{G}_{{A}^{′} {A}^{′}} & {G}_{{A}^{′} {{A}^{′}}^{c}}\end{matrix} ) = ( \begin{matrix}v & w & {x}_{{A}^{′c}}\end{matrix} ) \qquad Eq . ( 7 )$$

where x_{A′}_{^{c}} is the non-systematic portion of the codeword.

Next, the codeword bits may be mapped to symbols, sᵥ, t_{w} which are mapped to physical resources for transmission. In some embodiments, the same mechanism may be used for downlink transmissions. For facilitating a WTRU (user equipment, UE) to perform the joint channel estimation and polar decoding, the base station may indicate to the UE the parameters of J, D, and the UE may use such information together with the TBS and modulation and coding scheme (MCS) information to identify the information bits and pilot signal in the allocated downlink resources. For reception, the method moves instead to the joint polar decoding and channel estimation.

The set A plays two different roles: First, it is the set of information bit positions for the underlying polar code (representing the bit-channels with the highest capacity). Additionally, it is the set of positions in the codeword in which the information vector v will appear (such as where the pilots will also appear). The pilots are thus restricted to appear in a specific set of positions in the codeword, and thus are not guaranteed to be equally spaced. To circumvent this issue, another set of example methods in accordance with some embodiments are disclosed: non-systematic polar coding, which allows de-coupling the set of information bit positions of the polar code from the set of pilot positions.

In some embodiments, the method indicated in FIG. 7 includes receiving an indicator for joint channel estimation; receiving an indicator for pilot signal density; and responsive to receiving the indicator for joint channel estimation: setting the portion of allocated resources to be used for channel estimation according to the indicator for pilot signal density; mapping codeword bits to symbols; mapping symbols to allocated resources; and transmitting the symbols. For some embodiments of the method, transmitting the symbols includes transmitting a systematic polar coded signal and may also include using the indicator for pilot signal density and a transport block size to determine a length of a polar coding vector w and mapping a pilot sequence based on the polar coding vector w. Some embodiments of the method may be performed by a user equipment (UE) or by a base station.

In some embodiments, a method of wireless communication may include receiving an indicator for joint channel estimation; receiving an indicator for pilot signal density; and responsive to receiving the indicator for joint channel estimation: using the indicator for pilot signal density to identify information bits and pilot signal in a received signal; and performing joint polar decoding and channel estimation. For some embodiments of the method, transport block size may additionally be used to identify information bits and pilot signal in a received signaling. For some embodiments, receiving is receiving at a UE, and the received signal is an allocated downlink resource. For some embodiments, receiving is receiving at a base station.

In some embodiments, a method of wireless communication includes receiving, at a UE, an indicator for joint channel estimation; receiving, at the UE, an indicator for pilot signal density; and responsive to receiving the indicator for joint channel estimation: performing systematic polar decoding. A system for wireless communication may include: a processor; and a non-transitory computer-readable medium storing instructions that are operative, when executed by the processor, to perform the methods disclosed herein.

### Joint Channel Estimation and Non-Systematic Polar Coding.

FIG. 8 illustrates an example of joint channel estimation and non-systematic polar coding, according to some embodiments. Pilot positions are located as indicated. Let B be the set of pilot positions in the codeword x_{B}=0. This imposes some parity check constraints that the vector u_{A} should satisfy. Note that that the frozen bits are set to zero. Let \tilde{H} be the parity check matrix representing these constraints, let \tilde{C} be the corresponding code, and let \tilde{G} be the generator matrix. It can be seen that x_{B}=0=u_{A}G_{AB}, and thus \tilde{H}=(G_{AB})^{T}.

Up to this point, the code \tilde{C} is fully defined by \tilde{H}. Indeed, if computational complexity is not a burden, and if the systematic version of the code \tilde{C} is used, it can be seen that encoding of this process can be accomplished in O(N²) (generator matrix multiplication), while decoding complexity can be kept at O(N log N), for any sets A and B.

For the following, if the pilot spacing is chosen to be a fixed power of two (2), then both encoding and decoding of this process can be accomplished in O(N log N), and thus the low computational complexity of polar encoding and decoding is preserved.

Let p be the number of pilots to be sent in the codeword |B|=p, and assume that p is a power of 2. Therefore, the pilot spacing

$$r = \frac{N}{P}$$

is also a power of 2. Referring to Eq. (1), generator matrices for polar codes with smaller blocklengths appear as sub-matrices of the generator matrix of the larger blocklength. For illustration, assume p=8, so that

$${G}_{N} = [ \begin{matrix}{G}_{r} & 0 & 0 & 0 & 0 & 0 & 0 & 0 \\ {G}_{r} & {G}_{r} & 0 & 0 & 0 & 0 & 0 & 0 \\ {G}_{r} & 0 & {G}_{r} & 0 & 0 & 0 & 0 & 0 \\ {G}_{r} & {G}_{r} & {G}_{r} & {G}_{r} & 0 & 0 & 0 & 0 \\ {G}_{r} & 0 & 0 & 0 & {G}_{r} & 0 & 0 & 0 \\ {G}_{r} & {G}_{r} & 0 & 0 & {G}_{r} & {G}_{r} & 0 & 0 \\ {G}_{r} & 0 & {G}_{r} & 0 & {G}_{r} & 0 & {G}_{r} & 0 \\ {G}_{r} & {G}_{r} & {G}_{r} & {G}_{r} & {G}_{r} & {G}_{r} & {G}_{r} & {G}_{r}\end{matrix} ] \qquad Eq . ( 8 )$$

The lower-triangular structure of this matrix, along with the fact each column in the matrix should satisfy exactly one parity check equation, imply that the information vector of the polar code (vector u in FIG. 8) can be divided into chunks of length r, where each chunk should satisfy exactly one parity check equation (irrespective of other chunks). Therefore, the encoding of each chunk can be done in O(r), and as there are p chunks, the encoding complexity of the code \tilde{C} is O(rp)=O(N). Hence, the overall encoding complexity (including polar encoding) is O(N log N).

One interesting special case of this encoding scheme is when pilots are sent starting from the r^{th} position, such as when the pilot positions are multiples of a power of 2. Since the final column of the generator matrix of a polar code has a weight of 1, this implies that the parity check equations that the vector u should satisfy include a single element of the vector set to 0. Therefore, these elements can be incorporated into the frozen bits of the polar code, and thus, in this case, the method doesn't consume the rate of the underlying polar code.

In some embodiments, for example in a cellular system, the operation may be as illustrated in FIG. 9. FIG. 9 illustrates a flow chart of an example method that may be performed by a WTRU for joint channel estimation and non-systematic polar coding for the uplink, according to some embodiments. The method of FIG. 9 has similarities with the method of FIG. 7, although there are some differences. In the top box, D may be as indicated in Table 1, with values of {0,1,2,3} that indicate densities { 1/32, 1/16,⅛,¼}, respectively.

If J=1, the size of set B is determined: Some columns of the generator matrix may correspond to pilot locations. The sets B, H are determined, which may impose a constraint on polar encoder input. The base station may send the configuration for joint channel estimation and polar coding in a DCI, which may contain parameters such as the modulation and coding index (I_{MCS}), the indicator for joint channel estimation and polar coding J, and the pilot signal density parameter D.

The pilot density parameter D may be used, together with the transport block size (TBS) may be used by the UE to determine the size of set B. For example,

|B|=ceiling(TBS×(pilot density)) Eq. (9)

where ∥ stands for the cardinality of a set.

The locations of B are then determined. The locations identify a subset of the columns of the generator matrix G. The elements of the codeword x are set to 0, i.e., x_{B}=0. The constraints define a parity check matrix \tilde{H}=(G_{AB})^{T}.

Consider the scenario of using positions at multiples of a power of 2. The affected bits in the u vector number as many as the pilot bits. These affected bits in u can be set to the frozen bits. Next, the codeword bits may be mapped to symbols, sᵥ, t_{B} which are then mapped to physical resources for transmission. For reception, the method moves instead to the joint polar decoding and channel estimation. The following proves that the affected bits in the u vector are as many as the pilot bits. Let the set of pilot positions be Bᵣ={αr|α=1, 2, . . . , p}, where p≤N is a power of 2, and r=N/p which is a power of 2 since N is also a power of 2. It may be established that G_{B}_{ᵣ}_{^{c}}_{B}_{ᵣ}=0. To see why this is true, notice that G can be considered as tiled by the matrix Gᵣ and the r×r zero matrix. The columns of G identified by the set Bᵣ will consist of length-r vectors [0, 0, . . . , 0, 1]^{T} (all but the last element being 0) or [0, 0, . . . , 0, 0]^{T}, where ^{τ} stands for transpose. One example (r=4, p=2, N=8) is as follows:

$$[ \begin{matrix}0 & 0 \\ 0 & 0 \\ 0 & 0 \\ 1 & 0 \\ 0 & 0 \\ 0 & 0 \\ 0 & 0 \\ 1 & 1\end{matrix} ]$$

Taking the rows of G identified by Bᵣ^{c}, the elements at the intersections will be 0, such that G_{B}_{ᵣ}_{^{c}}_{B}_{ᵣ}=0. Next, note that

x_{B}_{ᵣ}=u_{B}_{ᵣ}^{c}G_{B}_{ᵣ}_{^{c}}_{B}_{ᵣ}+u_{B}_{ᵣ}G_{B}_{ᵣ}_{B}_{ᵣ} Eq. (10)

### Thus,

x_{B}_{ᵣ}=u_{B}_{ᵣ}G_{B}_{ᵣ}_{B}_{ᵣ} Eq. (11)

Setting x_{B}_{ᵣ}=0 yields

u_{B}_{ᵣ}G_{B}_{ᵣ}_{B}_{ᵣ}=0, Eq. (12)

which implies that u_{B}_{ᵣ} is in the null space of (G_{B}_{ᵣ}_{B}_{ᵣ})^{T}. Note that G_{B}_{ᵣ}_{B}_{ᵣ} is a lower triangular matrix. Also note that the diagonals of G_{B}_{ᵣ}_{B}_{ᵣ} are taken from the diagonals of G, whose diagonals are all ones. So the diagonals of G_{B}_{ᵣ}_{B}_{ᵣ} are all ones, and hence G_{B}_{ᵣ}_{B}_{ᵣ} full rank. Thus,

u_{B}_{ᵣ}=0, Eq. (13)

which is the only requirement to make

x_{B}_{ᵣ}=0. Eq. (14)

In some embodiments, the method indicated in FIG. 9 includes receiving an indicator for joint channel estimation; receiving an indicator for pilot signal density; and responsive to receiving the indicator for joint channel estimation: setting the portion of allocated resources to be used for channel estimation according to the indicator for pilot signal density; mapping codeword bits to symbols; mapping symbols to allocated resources; and transmitting the symbols. For some embodiments of the method, transmitting the symbols may include transmitting a non-systematic polar coded signal and may also include using the indicator for pilot signal density and a transport block size to determine a length of a polar coding set B and mapping a pilot sequence based on the polar coding set B. Some embodiments of the method may be performed by a user equipment (UE) or by a base station.

For another embodiment of a method of performing joint channel estimation and polar coding is to introduce constraints on the output bits of a polar encoder output. These constraints may then be used in channel estimation and polar decoding. Let the pilot positions be C, and the constraint may be written as Ax_{c}=D, where A is an m×|C| matrix, D is an m×1 vector of binary-valued entries, and the multiplication and addition are in Galois Field 2 (GF(2)). The pilot signal is not fully known, and therefore this approach may be considered as a semi-blind approach for channel estimation.

As an example, consider C={1,5,9,13}, and

$$\begin{matrix}A = [ \begin{matrix}0 & 1 & 1 & 0 \\ 1 & 0 & 1 & 1\end{matrix} ] , & Eq . ( 15 ) \\ D = [ \begin{matrix}1 \\ 0\end{matrix} ] & Eq . ( 16 )\end{matrix}$$

The constraints will then be

x₅+x₉=1, Eq. (17)

x₁+x₉+x₁₃=0. Eq. (18)

One approach for determining a solution may be to sequentially attempt different possible values for x_{C}, and for each possible value, perform channel estimate and then polar decoding. Other simultaneous solution approaches may also be developed by considering channel estimation and polar decoding simultaneously. For example, the problem may be formulated as follows:

$${u}^{*} = \begin{matrix}argmin \\ uG = x , {Ax}_{c} = D\end{matrix} {\sum }_{i = 0}^{Q - 1} {\vert {y}_{i} - H {f}_{i} ( x ) \vert}^{2} \qquad Eq . ( 19 )$$

where yᵢ is the received vector at the ith symbol time, H is the channel matrix, and fᵢ(x) is the transmitted symbols corresponding to codeword x at the ith symbol time, Since a codeword typically is longer than what can be transmitted in a single symbol time, Q is used to denote the number of symbol time intervals needed for transmitting the symbols resulting from codeword x. The constraint Ax_{C}=D may then be used in the successive cancellation decoding with list decoding of the polar code.

In some embodiments, a method of wireless communication may include receiving an indicator for joint channel estimation; receiving an indicator for pilot signal density; and responsive to receiving the indicator for joint channel estimation: using the indicator for pilot signal density to identify information bits and pilot signal in a received signal; and performing joint polar decoding and channel estimation. For some embodiments of the method, transport block size may additionally be used to identify information bits and pilot signal in a received signaling. For some embodiments, receiving is receiving at a UE, and the received signal is an allocated downlink resource. For some embodiments, receiving is receiving at a base station.

In some embodiments, a method of wireless communication includes receiving, at a UE, an indicator for joint channel estimation; receiving, at the UE, an indicator for pilot signal density; and responsive to receiving the indicator for joint channel estimation: performing non-systematic polar coding. A system for wireless communication may include: a processor; and a non-transitory computer-readable medium storing instructions that are operative, when executed by the processor, to perform the methods disclosed herein.

### Simulation Results and Variations.

FIGS. 10-12 illustrate simulation results for channel models, according to some embodiments. In the simulations of FIG. 1012, the channel is modeled using a first-order Markov model, with channel transition probability α. The higher the value of α, the faster the channel varies either across frequency or over time. For the baseline (separate channel estimation and polar coding), a cyclic redundancy check (CRC) of 16 bits and a pilot signal of 64 bits are used. The block length is 1024. The communication rate may be defined as the ratio of the number information bits to the number of channel uses. The block length includes the pilot bits. When the CRC is used, the block length also includes the CRC bits.

FIG. 10 illustrates two curves. The upper curve is the block error probability (BLER) versus signal to noise ratio (SNR) for the baseline (separate channel estimation and Polar coding). The lower curve is BLER versus SNR for an embodiment of a joint channel estimation and non-systematic polar coding method. The channel is a slowly changing channel, with α= 1/64.

FIG. 11 also illustrates two curves. The upper curve is BLER versus SNR for the baseline. The lower curve is BLER versus SNR for an embodiment of a joint channel estimation and non-systematic polar coding method. The channel is a rapidly changing channel, with α= 1/16.

FIG. 12 illustrates multiple sets of curves. The solid curves are BLER versus SNR for the baseline. The dashed curve curves are BLER versus SNR for an embodiment of a joint channel estimation and non-systematic polar coding method. The channel is a slowly changing channel, with α= 1/64. As indicated in the legend, various list sizes L are used, L={1,4,8,16}.

In the example simulations, the communication rate is the same for both the baseline (separate channel estimation and Polar coding) and joint channel estimation and non-systematic polar coding methods. As can be seen from FIGS. 10-12, the joint channel estimation and non-systematic polar coding method outperforms the baseline methods. Specifically, the error rate (BLER) is lower for a given SNR with the joint channel estimation and non-systematic polar coding method than for the baseline method.

The same or similar scheme may also be used for downlink transmissions, in some embodiments. For facilitating the UE to perform joint channel estimation and polar decoding, the base station may indicate to the UE the parameters of J and D, and the UE may use such information together with the TBS and MCS information to identify the information bits and pilot signal in the allocated downlink resources.

In some exemplary embodiments, a WTRU (UE) is instructed to perform joint channel estimation and polar coding for the uplink transmission. The configuration is carried in the DCI, sent from the base station. The UE calculates the amount of resources needed for the uplink reference signal, based on a pilot density and a transport block size. The UE sets a subset of the polar code output to some known values (such as perhaps zero), which are used as pilot signals and may only affect the frozen bits of the polar code. In some embodiments, a UE may perform joint channel estimation and polar coding for the uplink transmission. In some embodiments, a UE may perform joint channel estimation and polar coding for the downlink transmission. In some embodiments, a UE may perform joint channel estimation and systematic polar coding for the uplink transmission. In some embodiments, a UE may perform joint channel estimation and systematic polar coding for the downlink transmission.

In some embodiments an indicator for joint channel estimation (e.g., received or transmitted, used during uplink or downlink transmission, by, e.g., a UE or a base station, for example) includes an indicator for joint processing that includes both channel estimation and polar coding (e.g., polar encoding or polar decoding). In some embodiments, the polar coding may be systematic, e.g., in accordance with example methods disclosed herein. In other embodiments, the polar coding may be non-systematic, e.g., in accordance with example methods disclosed herein.

In some embodiments, other techniques than providing a dedicated bit field indicator (e.g., a binary valued indicator such as, for example, J=1 for joint processing and J=0 for separate processing in some embodiments) may be used to indicate joint channel estimation (joint channel estimation and polar coding).The specific implementation may depend on implementations at the transmitter, the receiver, uplink transmission, downlink transmission. For example, in some embodiments, the indication may be inferred from another condition or set of conditions.

Iteratively Incorporating Reliably-Decoded Bits into the Set of Pilots

### Channel Model

The following embodiment demonstrates the methods described herein using a narrowband finite-state channel with binary phase shift keying (BPSK) modulation, where the channel state follows a first-order Markov distribution. The received signal at time i in a block of length N is expressed as:

yᵢ=hᵢs(xᵢ)+nᵢ Eq. (20)

where:

xᵢ∈{0,1}is the i-th output of a polar encoder, and s:{0,1}→{−1,1} is the mapping corresponding to antipodal modulation,

nᵢ∈R is a white Gaussian noise process with covariance matrix σ²I,

yᵢ∈R is the channel output for the i th transmission,

hᵢ∈H={−1,1} is the channel gain and follows a first-order Markov distribution with P(Hᵢ=−1|Hᵢ₋₁=+1)=P(Hᵢ=+1|Hᵢ₋₁=−1)=α and H₀ is uniformly distributed over H (i.e. P(H₀=+1)=P(H₀=−1)=½). It is also assumed that Hᵢ and Xᵢ are independent, i.e. the transmitter has no channel state information. The set H models the extreme case where the phase information of the transmitted signal is either unaltered or completely lost due to fading.

### Successive Cancellation Trellis Decoding.

As discussed above, polar codes have been described by Arikan (“Arikan_1”)), and polar codes are one of the recent breakthroughs in coding theory. These codes achieve the symmetric capacity on any binary discrete memoryless channel and also have low encoding and decoding complexities. A fundamental component of the polar coding scheme is a successive cancellation decoder which, for the specific construction of polar codes, can be implemented efficiently.

After the introduction of polar codes, attempts followed to apply polar codes for channels with memory. In Sasoglu, “Polarization in the presence of memory,” in 2011 IEEE International Symposium on Information Theory Proceedings, pp. 189-193, July 2011, and E. Sasoglu, “Polar coding theorems for discrete systems,” p. 104, 2011 (“Sasoglu 2”) Sasoglu showed that the channels (Yᵢ,Hᵢ|Xᵢ,Hᵢ₋₁) polarize under a similar recurrence as that for memoryless channels. In R. Wang, R. Liu, and Y. Hou, “Joint successive cancellation decoding of polar codes over intersymbol interference channels,” CoRR, vol. abs/1404.3001, 2014 and R. Wang, J. Honda, H. Yamamoto, R. Liu, and Y. Hou, “Construction of polar codes for channels with memory,” in 2015 IEEE Information Theory Workshop—Fall (ITW), pp. 187-191, October 2015, a generalized successive cancellation decoder is proposed for channels with memory, namely the successive cancellation trellis decoder (SCTD). It is shown in I. Tal and A. Vardy, “List decoding of polar codes,” IEEE Transactions on Information Theory, vol. 61, pp. 2213-2226, May 2015 that polar codes with SCTD decoding achieve the capacity of finite-state Markov channels. The SCTD algorithm is briefly described herein.

Let N=2ⁿ be the blocklength of a polar code, and u_{I}^{N} be the input vector to a polar encoder (consisting of information and frozen bits). The implementation of any polar coding scheme requires the computation of

$${P}_{{U}_{1}^{i}} ( {u}_{1}^{i} ) {f}_{{Y}_{1}^{N} \vert {U}_{1}^{i}} ( {y}_{1}^{N} \vert {u}_{1}^{i} ) ,$$

where y₁^{N} is the received channel output. For a finite-state channel model, this expression can be written as

$$\begin{matrix}{P}_{{U}_{1}^{i}} ( {u}_{1}^{i} ) {f}_{{Y}_{1}^{N} \vert {U}_{1}^{i}} ( {y}_{1}^{N} \vert {u}_{1}^{i} ) = {\sum }_{{h}_{0} , {h}_{N}}^{ } {P}_{{H}_{0}} ( {h}_{0} ) {P}_{{U}_{1}^{i}} ( {u}_{1}^{i} ) {P}_{{H}_{N} \vert {H}_{0}} ( {h}_{N} \vert {h}_{0} ) . & Eq . ( 21 ) \\ {f}_{{Y}_{1}^{N} \vert {U}_{1}^{i} , {H}_{N} , {H}_{0}} ( {y}_{1}^{N} \vert {u}_{1}^{i} , {h}_{N} , {h}_{0} ) , & \end{matrix}$$

where H₀,H_{N} are the random variables associated with the initial and final states, respectively. Therefore, the expression in Eq. (21) can be computed from

$${φ}_{N}^{( N )} ( {y}_{1}^{N} , {u}_{1}^{i} , {h}_{N} \vert {h}_{0} )$$

$${P}_{{U}_{1}^{i}} ( {u}_{1}^{i} ) {P}_{{H}_{N} \vert {H}_{0}} ( {h}_{N} \vert {h}_{0} ) {f}_{{Y}_{1}^{N} \vert {U}_{1}^{i} , {H}_{N} , {H}_{0}} ( {y}_{1}^{N} \vert {u}_{1}^{i} , {h}_{N} , {h}_{0} ) = {\sum }_{{u}_{i + 1}^{N}} \frac{1}{{2}^{N}} {P}_{{H}_{N} \vert {H}_{0}} ( {h}_{N} \vert {h}_{0} ) {f}_{{Y}_{1}^{N} \vert {U}_{1}^{i} , {H}_{N} , {H}_{0}} ( {y}_{1}^{N} \vert {u}_{1}^{N} , {h}_{N} , {h}_{0} )$$

The main idea of SCTD is that the functions ϕ_{N}⁽ⁱ⁾(y₁^{N},u₁ⁱ,h_{N}|h₀) can be evaluated recursively, as follows (1≤i≤N):

$$\begin{matrix}{φ}_{2 N}^{( 2 i - 1 )} ( {y}_{1}^{2 N} , {u}_{1}^{2 i - 1} , {h}_{2 N} \vert {h}_{0} ) = {\sum }_{{h}_{N}^{′}}^{ } {\sum }_{{u}_{2 i}}^{ } ( {φ}_{N}^{( i )} ( {y}_{1}^{N} , {u}_{1 , o}^{2 i} ⊕ {u}_{1 , e}^{2 i} , {h}_{N}^{′} \vert {h}_{0} ) . & Eq . ( 22 ) \\ {φ}_{N}^{( i )} ( {y}_{N + 1}^{2 N} , {u}_{1 , e}^{2 i} , {h}_{2 N} \vert {h}_{N}^{′} ) ) & \\ {φ}_{2 N}^{( 2 i )} ( {y}_{1}^{2 N} , {u}_{1}^{2 i} , {h}_{2 N} \vert {h}_{0} ) = {\sum }_{{h}_{N}^{′}}^{ } ( {φ}_{N}^{( i )} ( {y}_{1}^{N} , {u}_{1 , o}^{2 i} ⊕ {u}_{1 , e}^{2 i} , {h}_{N}^{′} \vert {h}_{0} ) . & Eq . ( 23 ) \\ {φ}_{N}^{( i )} ( {y}_{N + 1}^{2 N} , {u}_{1 , e}^{2 i} , {h}_{2 N} \vert {h}_{N}^{′} ) ) & \end{matrix}$$

with “base” condition

ϕ₁⁽¹⁾(yᵢ,xᵢ,hᵢ|hᵢ₋₁)=½P_{H}_{ᵢ}_{|H}_{ᵢ₋₁}(hᵢ|hᵢ₋₁)W(yᵢ|xᵢ,hᵢ) Eq. (24)

where u_{1,o}²ⁱ and u_{1,e}²ⁱ denote the subsequences of u₁²ⁱ consisting of odd and even indices, respectively, and W(yᵢ|xᵢ,hᵢ) are the conditional probability density functions of the channel for a given channel input xᵢ and channel state hᵢ. Note that the base condition (Eq. 24) along with the recursive equations (22) and (23), are evaluated for all hᵢ, hᵢ₋₁∈H and xᵢ∈{0,1}. It can be checked that the complexity of SCTD is O(|H|³ N log N).

Note that SCTD can be generalized to list decoding of polar codes (See, A. Viterbi, “Error bounds for convolutional codes and an asymptotically optimum decoding algorithm,” IEEE Transactions on Information Theory, vol. 13, pp. 260-269, April 1967), and the complexity of an SC trellis list decoder is O(|H|³ LN log N), where L is the list size.

Most currently deployed solutions that handle channel uncertainty involve inserting known pilot symbols periodically to track the time variation of the channel. Using the received symbols and the known pilot symbols, the receiver estimates the channel gain at the pilot positions, and applies an interpolation to get an estimate of the channel at the data symbol positions.

Adapting this approach to our channel model, the receiver first applies the forward-backward algorithm of hidden markov models (See, L. Baum and T. Petrie, “Statistical inference for probabilistic functions of finite state markov chains,” Annals of Mathematical Statistics, vol. 37, pp. 1554-1563, 1966) to get estimates of the channel at the pilot positions. Namely, if B is the set of pilot positions, the forward-backward algorithm can be used to compute probabilities P(hᵢ|y_{B}) and P(hᵢ,hⱼ|y_{B}), where i and j are two consecutive indices in B, for all hᵢ, hⱼ∈H. Once these probabilities are computed, interpolation to non-pilot positions can follow easily by the knowledge of the distribution of the channel gain, i.e. for i∉B, hᵢ∈H,

$$P ( {h}_{i} \vert {y}_{B} ) = {\sum }_{{h}_{prev} , {h}_{next}}^{ } P ( {h}_{prev} , {h}_{next} \vert {y}_{B} ) P ( {h}_{i} \vert {h}_{prev} , {h}_{next} ) ,$$

where

$$prev = {max}_{k} \{ k ∈ B , k < i \} and next = {min}_{k} \{ k ∈ B , k > i \} .$$

The receiver then computes estimates of the channel gains as

$${\hat{h}}_{i} = {max}_{{h}_{i} ∈ H} P ( {h}_{i} \vert {y}_{B} )$$

and performs conventional SC decoding. This approach will be referred to hereon as “Reference Scheme 1”.

The knowledge of the pilot bit positions can be exploited at the decoder side. Recall the finite-state Markov channel model described in Sasoglu 2. Clearly, the SCTD algorithm can be used for decoding. Described herein are variants of the SCTD algorithm that can incorporate the channel estimates into the decoding procedure.

1. Embodiments using channel estimates in SCTD will be described: Channel estimates at pilot positions can be computed in two different ways for our channel model:

(a) Hard estimates from the Viterbi algorithm: The Viterbi algorithm can be used to get an optimal sequence estimator of the channel gains at pilot positions. Recall the recursive equations Eq. (22) and Eq. (23), and the base condition Eq. (24). For every pilot position i∈B, the channel estimate from Viterbi at that position, say ĥᵢ, is assumed to be correct, i.e. H, is assumed to be deterministic. Also, the knowledge of the zero pilot bit can be exploited in SCTD as well. Therefore, the following modification to the base condition in SCTD is proposed: for every i∈B, set

$${φ}_{1}^{( 1 )} ( {y}_{i} , {x}_{i} , {h}_{i} \vert {h}_{i - 1} ) = \{ \begin{matrix}0 , & if {h}_{i} \neq {\hat{h}}_{i} {or x}_{i} = 1 \\ \frac{1}{2} W ( {y}_{i} \vert {x}_{i} , {h}_{i} ) & otherwise .\end{matrix} \qquad Eq . ( 25 )$$

This modification to the SCTD algorithm forces any traversal of the trellis structure of the channel gain distribution to pass by the estimate ĥᵢ at the pilot position i (see FIG. 13). For non-pilot positions, the knowledge of channel gains at subsequent positions can be incorporated to SCTD as well. This corresponds to computing the probabilities in (Eq. 21) conditioned on the estimated channel gains ĥ_{B}, i.e.

$${P}_{{Y}_{1}^{N} , {U}_{1}^{i} \vert {H}_{B}} ( {y}_{1}^{N} , {u}_{1}^{i} \vert {\hat{h}}_{B} ) .$$

It is easy to check that the corresponding modification to the base condition Eq. (24) is to set, for every i∉B,

$${φ}_{1}^{( 1 )} ( {y}_{i} , {x}_{i} , {h}_{i} \vert {h}_{i - 1} , {\hat{h}}_{k} ) = \frac{1}{2} {P}_{{H}_{i} \vert {H}_{i - 1} , {H}_{next}} ( {h}_{i} \vert {h}_{i - 1} , {\hat{h}}_{next} ) W ( {y}_{i} \vert {x}_{i} , {h}_{i} ) , \qquad Eq . ( 26 )$$

where

$$next = {min}_{j} \{ j > i ; j ∈ B \}$$

and ĥₙₑₓₜ the estimated channel gain at the subsequent pilot position.

A modification to SCTD is shown in FIG. 13, where Viterbi gives ĥᵢ=+1. The values on arrows denote transition probabilities.

(b) Soft estimates from the forward-backward algorithm: As previously mentioned, the method may use the forward-backward algorithm to compute probabilities P(hᵢ|y_{B}) for every i∈B, hᵢ∈H. Under the assumption that Hᵢ: p, where \hat{p}(hᵢ)=P(hᵢ|y_{B}), and using a modified base condition as follows: for every i∈B, hᵢ∈H, set

$${φ}_{1}^{( 1 )} ( {y}_{i} , {x}_{i} , {h}_{i} \vert {h}_{i - 1} ) = \{ \begin{matrix}0 , & {if x}_{i} = 1 \\ \frac{1}{2} \hat{p} ( {h}_{i} ) W ( {y}_{i} \vert {x}_{i} , {h}_{i} ) & otherwise .\end{matrix} \qquad Eq . ( 27 )$$

The modifications Eq. (25), Eq. (26), and Eq. (27) allow use of the knowledge from the estimation of the channel state in channel decoding. Unlike other scenarios, the knowledge of the Markov property of the channel gain is used in the decoding process, as per SCTD.

2. Embodiments using two-stage decoding scheme using list decoding of polar codes will be described: Recall that the output of a list decoder is a list of L candidate codewords {(x₁^{N})₁, . . . , (\hat{x}₁^{N})_{L}}, along with the probabilities

$${P}_{{Y}_{1}^{N} , {X}_{1}^{N}} ( {y}_{1}^{N} , {( {\hat{x}}_{1}^{N} )}_{j} ) , 1 \leq j \leq L .$$

In some embodiments, these probabilities are used to compute reliability measures over each bit in the codeword, and the reliably-decoded bits are reused as “pilots” in a subsequent iteration of channel estimation. More specifically, compute, for 1≤i≤N, b∈{0,1}

$${w}_{i} ( b ) = {\sum }_{j = 1 , {( {x}_{i} )}_{j} = b}^{L} {P}_{{Y}_{1}^{N} , {X}_{1}^{N}} ( {y}_{1}^{N} , {( {\hat{x}}_{1}^{N} )}_{j} )$$

$${\tilde{w}}_{i} ( b ) = \frac{{w}_{i} ( b )}{{\sum }_{{b}^{′} ∈ \{ 0 , 1 \}} {w}_{i} ( {b}^{′} )} ,$$

where (xᵢ)ⱼ is the i-th bit of the j-th candidate codeword. \tilde{w}ᵢ(b) represents the fraction of codewords in the list that take the value b in the i-th position. If \tilde{w}ᵢ(b)≥γ for some γ∈(0,1], we declare that bit b is reliable, and its value at the i-position, along with the original pilot symbols, is used to re-estimate the channel gains at the corresponding positions, and then another run of SCTD is performed with the new larger set of channel estimates.

The decoding performance of the proposed scheme compared to the Reference Scheme 1 presented earlier is shown in FIG. 14. In one embodiment, the selected configuration uses a blocklength N=1024, a list size L=32, and the number of pilots in each codeword is p=64 (i.e. one pilot every 16 positions). The schemes are compared for the same overall communication rate R=¼.

To check if the gain in the proposed scheme comes from SCTD decoding or from the knowledge of the pilot bits at the decoder side, we simulate a scheme which performs SCTD decoding, but where pilots are not sent as part of the codeword. This scheme is referred to in the plots as “Reference Scheme 2”. In the example shown, Reference Scheme 1 performs well, yet Reference Scheme 2 has significant performance gain compared to Reference Scheme 1. This indicates that averaging out uncertainty at the non-pilot positions, as per SCTD, is advantageous (compared to interpolating to find estimates at those positions).

Notice that Reference Scheme 2 uses the channel (N+p) times (since pilots are not part of the codeword in this scheme), whereas Reference Scheme 1 and the proposed scheme use the channel N times.

With respect to FIG. 14, the Block error probability performance of the different described schemes is depicted.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method of wireless communication, the method comprising:
receiving an indicator for joint channel estimation;
receiving an indicator for pilot signal density; and
responsive to receiving the indicator for joint channel estimation:
setting the portion of allocated resources to be used for channel estimation according to the indicator for pilot signal density;
mapping codeword bits to symbols;
mapping symbols to allocated resources; and
transmitting the symbols.

2. The method of claim 1 wherein transmitting the symbols comprises transmitting a systematic polar coded signal.

3. The method of claim 2 further comprising:
using the indicator for pilot signal density and a transport block size to determine a length of a polar coding vector W; and
mapping a pilot sequence based on the polar coding vector W.

4. The method of claim 1 wherein transmitting the symbols comprises transmitting a non-systematic polar coded signal.

5. The method of claim 4 further comprising:
using the indicator for pilot signal density and a transport block size to determine a length of a polar coding set B; and
mapping a pilot sequence based on the polar coding set B.

6. The method of claim 1 wherein receiving comprises receiving at a user equipment (UE).

7. The method of claim 1 wherein receiving comprises receiving at a base station.

8. The method of claim 1 wherein a subset of output bits of a polar encoder is generated such that the subset of output bits satisfies constraints known to a receiver, wherein the bits are useable as pilot or reference signals for channel estimation, and the constraints are useable in polar decoding.

9. A method of wireless communication, the method comprising:
receiving an indicator for joint channel estimation;
receiving an indicator for pilot signal density; and
responsive to receiving the indicator for joint channel estimation:
using the indicator for pilot signal density to identify information bits and pilot signal in a received signal; and
performing joint polar decoding and channel estimation.

10. The method of claim 9 wherein using the indicator for pilot signal density to identify information bits and pilot signal in a received signal comprises using the indicator for pilot signal density and a transport block size to identify information bits and pilot signal in a received signaling.

11. The method of claim 9 wherein receiving comprises receiving at a user equipment (UE), and the received signal is an allocated downlink resource.

12. The method of claim 9 wherein receiving is receiving at a base station.

13. A method comprising:
receiving a multicarrier symbol frame of polar encoded data;
determining a plurality of pilot subcarrier locations within the received multicarrier symbol frame having predetermined symbol values;
determining channel gain values based on signal observations associated with the plurality of predetermined pilot subcarrier locations;
decoding the multicarrier symbol frame using a polar decoding process, and based in part on a channel estimate formed from the channel gain values;
determining one or more pseudo-pilot subcarriers according to a reliability metric obtained from the polar decoding process;
updating the channel estimate based on signal observations associated with the determined pseudo-pilot subcarriers; and,
re-decoding the multicarrier symbol frame using a polar decoding process, and based in part on the updated channel estimate.

14. The method of claim 13 wherein the plurality of pilot subcarrier locations are determined according to a systematic polar encoding operation that includes fixed values in an encoded codeword.

15. The method of claim 13 wherein the plurality of pilot subcarrier locations are determined according to a non-systematic polar encoding operation that includes fixed values in an encoded codeword.

16. The methods of claim 13 wherein the plurality of pilot subcarrier locations are determined according to a pilot signal density parameter.

17. The method of claim 13 wherein channel gain values are determined according to a backward-forward calculation based on signal observations of pilot locations.

18. The method of claim 18 wherein the channel estimates are hard decision estimates obtained from a Viterbi decoding process.

19. The method of claim 18 wherein the Viterbi decoding process is used to obtain an optimal sequence estimator of channel gains at pilot positions.

20. The method of claim 19 wherein a successive cancellation trellis decoder SCTD process forces traversal of the trellis structure of the channel gain distribution to pass by the estimate ĥᵢ at the pilot subcarrier position i.
